(19) United States
(12) Patent Application Publication
(10) Pub. No.: US 2015/0119490 A1
(43) Pub. Date: Apr. 30, 2015

(54) DRY MORTAR AND EMULSION/DISPERSION BASED COMPOSITIONS

(71) Applicant: HERCULES INCORPORATED, Wilmington, DE (US)

(72) Inventors: Venkataram Krishnan, Landenberg, PA (US); Brigitte Rennert, Neuss (DE)

(21) Appl. No.: 14/521,942

(22) Filed: Oct. 23, 2014

Related U.S. Application Data
(60) Provisional application No. 61/897,876, filed on Oct. 31, 2013.

(51) Int. Cl. C04B 28/04; C04B 14/28; C04B 24/28; C04B 24/04; C04B 24/26; C04B 14/06; C04B 24/10

(52) U.S. Cl. CPC C04B 28/04; C04B 14/06; C04B 14/28; C04B 24/10; C04B 24/045; C04B 24/2623; C04B 24/2641; C04B 24/28
USPC 523/122; 524/5; 524/3; 524/8; 524/4

(57) ABSTRACT

The presently disclosed and claimed inventive concept(s) related to a dry mortar composition or an emulsion/dispersion based composition having hydrophobically modified polymer compositions. The dry mortar composition or an emulsion/dispersion based composition comprises one or more polymer emulsions and/or redispersible powders, and one or more hydrophobic, and water-resistant or water-repellent additive. The emulsion/dispersion based composition can be used as a grout, a joint filler, a mastic, a pasty, textured plaster, tile adhesive, structure-latex based render, silicate render, fine dispersion render for skim coat, dispersion based tile grout, acrylate based render, latex-based primer, and colorized latex-based renders.

### CROSS REFERENCE TO RELATED APPLICATIONS

The present application claims the benefit under 35 U.S.C. 119 (e) of U.S. Provisional Patent Application Ser. No. 61/897,876, filed on Oct. 31, 2013, the entire contents of which are hereby expressly incorporated herein by reference.

### BACKGROUND

1. Field of the Invention

The presently disclosed and/or claimed inventive process(es), procedure(s), method(s), product(s), result(s), and/or concept(s) (collectively hereinafter referred to as the “presently disclosed and/or claimed inventive concept(s)”) relates generally to a dry mortar composition or an emulsion/dispersion based composition having one or more hydrophobically modified polymer compositions. More particularly, but not by way of limitation, the presently disclosed and/or claimed inventive concept(s) relates to a dry mortar composition or an emulsion/dispersion based composition comprising one or more polymer emulsions or dispersion powder, and one or more hydrophobic, water-resistant or water-repellent additive.

2. Background of the Invention

Redispersible powders (RDPs) are used for construction applications such as in tile grout, tile cement, exterior insulating finishing systems (EIFS), water proofing, and self leveling floors. RDPs enhance bond strength, flexibility and abrasive resistance of dry mortars. RDPs are typically produced via spray drying of a variety of polymer emulsions (e.g. VAC/E, VAC/Veova, vinyl/acrylics, VAE/Acrylics, Acrylics, St/Ac etc.), protective colloids (e.g. polyvinyl alcohol) and anti caking agents (e.g. calcium carbonate, silica etc.).

U.S. Pat. No. 4,239,546, assigned to Russel et al., discloses all suitable types of waxes are modified with suitable polymers, in particular hydrocarbon polymers.

KR200928065A, assigned to IL SAN ENTPR CO LTD, discloses a polymer-modified mortar composition used for waterproof coating during construction which is based on ethylene vinyl acetate copolymer and/or styrene acrylic copolymer.

US20110257301A1, assigned to HENRY CO, discloses settable gypsum composition comprising water; a first additive comprising a vinyl acetate/ethylene copolymer in latex or emulsion form; and a second additive which is at least one of (i) a wetting agent and/or a surfactant; (ii) a titanium coupling agent, (iii) a zirconium coupling agent, and (iv) mixtures thereof.

WO2012073258A3, assigned to JOSHI et al., discloses a composition suitable for use in building construction comprising water, a thickener, a pH stabilizer, a preservative, a coalescing agent, a binder, bottom ash, silica particle mixture, stone grit, a filler, an extender, and an additive.

Ru Wang et al (Advanced Materials Research, Volume 687, Pages 100-106)) discloses use of silanes and siloxanes as hydrophobic additives in cement and mortar compositions.

WO1999028264A1, assigned to Sangyong Cement Singapore, discloses metal stearates as hydrophobic additives in cement and mortar compositions.

Also, addition of certain hydrophobic agents sometimes leads to reduction in strength of the mortar (both dry and wet). Hence there is still a need for an effective solution that provides a way to tune the degree of water resistance or repellency that can be achieved through a powder based approach.

### DETAILED DESCRIPTION OF THE INVENTIVE CONCEPT(S)

Before explaining at least one embodiment of the presently disclosed and/or claimed inventive concept(s) in detail, it is to be understood that the presently disclosed and/or claimed inventive concept(s) is not limited in its application to the details of construction and the arrangement of the components or steps or methodologies set forth in the following description or illustrated in the drawings. The presently disclosed and/or claimed inventive concept(s) is capable of other embodiments or of being practiced or carried out in various ways. Also, it is to be understood that the phraseology and terminology employed herein is for the purpose of description and should not be regarded as limiting.

Unless otherwise defined herein, technical terms used in connection with the presently disclosed and/or claimed inventive concept(s) shall have the meanings that are commonly understood by those of ordinary skill in the art. Further, unless otherwise required by context, singular terms shall include pluralities and plural terms shall include the singular.

All patents, published patent applications, and non-patent publications mentioned in the specification are indicative of the level of skill of those skilled in the art to which the presently disclosed and/or claimed inventive concept(s) pertains. All patents, published patent applications, and non-patent publications referenced in any portion of this application are herein expressly incorporated by reference in their entirety to the same extent as if each individual patent or publication was specifically and individually indicated to be incorporated by reference.

All of the articles and/or methods disclosed herein can be made and executed without undue experimentation in light of the present disclosure. While the articles and methods of the presently disclosed and/or claimed inventive concept(s) have been described in terms of preferred embodiments, it will be apparent to those of ordinary skill in the art that variations may be applied to the articles and/or methods and in the steps or in the sequence of steps of the method described herein without departing from the concept, spirit and scope of the presently disclosed and/or claimed inventive concept(s). All such similar substitutes and modifications apparent to those skilled in the art are deemed to be within the spirit, scope and concept of the presently disclosed and/or claimed inventive concept(s).

As utilized in accordance with the present disclosure, the following terms, unless otherwise indicated, shall be understood to have the following meanings.

The use of the word “a” or “an” when used in conjunction with the term “comprising” may mean “one,” but it is also consistent with the meaning of “one or more,” “at least one,” and “one or more than one.” The use of the term “or” is used to mean “and/or” unless explicitly indicated to refer to alternatives only if the alternatives are mutually exclusive, although the disclosure supports a definition that refers to only alternatives and “and/or.” Throughout this application, the term “about” is used to indicate that a value includes the inherent variation of error for the quantifying device, the method being employed to determine the value, or the variation that exists among the study subjects. For example, but not by way of limitation, when the term “about” is utilized, the designated value may vary by plus or minus twelve percent, or eleven percent, or ten percent, or nine percent, or eight percent, or seven percent, or six percent, or five percent, or four percent, or three percent, or two percent, or one percent. The use of the term “at least one” will be understood to include one as well as any quantity more than one, including but not limited to, 1, 2, 3, 4, 5, 10, 15, 20, 30, 40, 50, 100, etc. The term “at least one” may extend up to 100 or 1000 or more depending on the term to which it is attached. In addition, the quantities of 100/1000 are not to be considered limiting as lower or higher limits may also produce satisfactory results. In addition, the use of the term “at least one of X, Y, and Z” will be understood to include X alone, Y alone, and Z alone, as well as any combination of X, Y, and Z. The use of ordinal number terminology (i.e., “first”, “second”, “third”, “fourth”, etc.) is solely for the purpose of differentiating between two or more items and, unless otherwise stated, is not meant to imply any sequence or order or importance to one item over another or any order of addition.

As used herein, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. The term “or combinations thereof” as used herein refers to all permutations and combinations of the listed items preceding the term. For example, “A, B, C, or combinations thereof” is intended to include at least one of: A, B, C, AB, AC, BC, or ABC and, if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

As used herein, the term “g”, “gm” and “gram” refer to metric system unit of mass.

As used herein, the term “hydrophobic” and “hydrophobicity” refer to the physical property of a molecule/composition that is repellent or resistant from water.

As used herein, the term “emulsion” is used interchangeably with the term “dispersion” to mean a discontinuous liquid phase and/or particles in a continuous liquid phase.

As used herein, the term “defoamer” and “anti-foaming agent” refer to a chemical additive that reduces and hinders the formation of foam in industrial process of liquids, semi-solids, or solids. The terms anti-foaming agent and defoamer are used interchangeably.

The presently disclosed and claimed inventive concept(s) provides a dry mortar composition comprising at least one polymer emulsion or dispersion powder, at least one hydrophobic additive and a cement. The hydrophobic additive used in the presently disclosed and claimed inventive concept(s) is selected from the group consisting of an alkyl ketene dimer, an alkenyl ketene dimer, alkenyl succinic anhydride, polyethylene-paraffin emulsion stabilized or cross-linked with zirconium/titanium chelates, a cationic starch-stabilized alkyl ketene dimer, a 2-oxetanone dimer, a 2-oxetanone multimer, an acid succinic anhydride, and combinations thereof. The hydrophobic effect or hydrophobicity can be measured by the Karsten tube method or the mortar prism water absorption test.

In one non-limiting embodiment, the alkyl ketene dimer can be a starch-stabilized, alkyl ketene dimer, which is commercially available from Ashland Inc. under the trade name Aquapel™ 320. The alkenyl succinic anhydride is commercially available from Ashland Inc. under the trade name Prequel™ 2000E. The alkenyl succinic anhydride and/or alkenyl ketene dimer is commercially available from Ashland Inc. under the trade name of Prequel™ 710. The hydrophobic polyethylene-paraffin emulsion, stabilized or cross-linked with zirconium chelates can be nano-size distribution of a hydrophobic polyethylene-paraffin emulsion, stabilized with zirconium chelates, which is commercially available from Ashland Inc. under the trade name Wetcare™.

Hydrophobic additive used in the presently disclosed and claimed inventive concept(s) can be wax emulsion. In one non-limiting embodiment, the wax emulsion can be Paracol™ 802N, which is available from Ashland Inc.

The hydrophobic additive can be present in an amount from about 0.01% to about 10% by weight based on the total weight of the dry mortar composition. In one non-limiting embodiment, the hydrophobic additive can be present in an amount from about 0.01% to about 5% by weight based on the total weight of the dry mortar composition. In another non-limiting embodiment, the hydrophobic additive can be present in an amount from about 5% to about 10% by weight based on the total weight of the dry mortar composition. In yet another non-limiting embodiment, the hydrophobic additive can be present in an amount from about 0.01% to about 1% by weight based on the total weight of the dry mortar composition.

The polymer emulsions or dispersion powder can include, but are not limited to, vinyl-acetate ethylene copolymer, VAc/Veova copolymer, vinyl/acrylics copolymer, vinyl-acetate ethylene/acrylics copolymer, acrylics (co)polymer, styrene/acrylics copolymer, styrene-butadiene and other butadiene polymers, polyurethane dispersions and combinations thereof.

In one non-limiting embodiment, the polymer emulsion or dispersion powder can be a redispersible polymer powder. One specific example of the redispersible polymer powder is a water-redispersible polymer powder.

The water-redispersible polymer powders are those which break down into primary particles in liquid such as water, and then dispersed (“redispersed”) in water. The use of such polymer emulsions or dispersion powders in dry mortar composition is common and known to improve, depending on the type and addition rate, the adhesion on all kinds of substrates, the deformability of the mortars, the flexural strength and the abrasion resistance, to name only a few of several properties. The polymer powder can comprise one or more compounds selected from homopolymers and/or copolymers and/or terpolymers of one or monomers selected from the group consisting of vinyl esters of unbranched or branched C₁-C₁₅ alkylcarboxylic acids, (meth)acrylic ester of C₁-C₁₅ alcohols, vinylaromatics, olefins, dienes, and vinyl halogenides.

In one non-limiting embodiment, vinyl esters can be vinyl acetate; vinyl propionate; vinyl butyrate; vinyl 2-ethylhexanoate; vinyl laurate; 1-methylvinyl acetate; vinyl pivalate; vinyl acetate-ethylene copolymers with an ethylene content of from about 1 to about 60% by weight; vinyl ester-ethylene-vinyl chloride copolymers with an ethylene content of from about 1 to about 40% by weight and a vinyl chloride content of from about 20 to about 90% by weight; vinyl acetate copolymers with from about 1 to about 50% by weight of one or more copolymerizable vinyl esters such as vinyl laurate, vinyl pivalate, and vinyl esters of alpha-branched monocarboxylic acids having from about 5 to about 11 carbon atoms, especially Versatic acid vinyl esters, which may also contain from about 1 to about 40% by weight of ethylene; and vinyl acetate-acrylic ester copolymers with from about 1 to about 60% by weight of acrylic ester, especially n-butyl acrylate or 2-ethylhexyl acrylate, and which may also contain from about 1 to about 40% by weight of ethylene.

If desired, the polymers may also contain from about 0.1 to about 10% by weight, based on the overall weight of the polymer, of functional comonomers. These functional comonomers may include, but are not limited to, ethylenically unsaturated monocarboxylic or dicarboxylic acids such as acrylic acid; ethylenically unsaturated carboxyamides such as (meth)acrylamide; ethylenically unsaturated sulfonic acids and/or their salts such as vinylsulfonic acid; polyethylenically unsaturated comonomers such as divinyl adipate, diallyl maleate, allyl methacrylate and triallyl cyanurate; and/or N-methylol (meth)acrylamides and their ethers, for example their isobutoxy or n-butoxy ethers.

Methacrylic esters or acrylic esters can be, but are not limited to, methyl acrylate, methyl methacrylate, ethyl acrylate, ethyl methacrylate, propyl acrylate, propyl methacrylate, n-butyl acrylate, n-butyl methacrylate, 2-ethylhexyl acrylate, and copolymers of methyl methacrylate with 1,3-butadiene.

Vinylaromatics can be, but are not limited to, styrene, methylstyrene, and vinyltoluene, styrene-butadiene copolymers and styrene-acrylic ester copolymers such as styrene-n-butyl acrylate or styrene-2-ethylhexyl acrylate, each with a styrene content of from about 10 to about 70% by weight.

Vinyl halide can be vinyl chloride. Vinyl chloride polymers can be, but are not limited to, vinyl ester/vinyl chloride/ethylene copolymers, vinyl chloride-ethylene copolymers and vinyl chloride-acrylate copolymers.

In one non-limiting embodiment, olefins can be ethylene and propylene, and dienes can be 1,3-butadiene and isoprene.

The polymers can be prepared in a conventional manner. In one non-limiting embodiment, the polymer can be prepared by an emulsion polymerization process. The dispersions used may be stabilized with emulsifier or else with a protective colloid, an example being polyvinyl alcohol. To prepare the water-redispersible polymer powders, the polymer dispersion obtainable in this way can be dried. Drying may be conducted by means of spray drying, freeze drying, or by coagulation of the dispersion and subsequent fluidized bed drying. The water-redispersible polymer powder may comprise one or more compounds selected from protective colloids and antiblocking agents. EP1498446A1 discloses methods and examples of producing such water-redispersible polymer powders, the entire contents of which is hereby expressly incorporated herein by reference.

The polymer emulsions or dispersion powder can be in an amount between about 0.25% and about 50%. In one non-limiting embodiment, the polymer emulsions or dispersion powder can be between about 0.4% and about 40% weight based on the total weight of the dry mortar composition. In another non-limiting embodiment, the polymer emulsions or dispersion powder can be between about 0.7 and about 30% by weight based on the total weight of the dry mortar composition.

The cements can be hydraulic cements. Examples of the hydraulic cement can include, but are not limited to, Portland cement, Portland-slag cement, Portland-silica fume cement, Portland-pozzolana cement, Portland-burnt shale cement, Portland-limestone cement, Portland-composite cement, blast furnace cement, pozzolana cement, composite cement, and calcium aluminate cement.

The dry mortar composition of the presently disclosed and claimed inventive concept(s) can further comprise an aggregate material, an inorganic compound, a surfactant, a defoamer, and cellulose ether.

Examples of the aggregate material can be, but are not limited to, silica sand, dolomite, limestone, lightweight aggregates (e.g. perlite, expanded polystyrene, hollow glass spheres), rubber crumbs (recycled from car tires), ceramic spheres, and fly ash.

For the dry mortar composition of the presently disclosed and claimed inventive concept(s), the aggregates can also have a particle size of up to 5 mm. In one non-limiting embodiment, the aggregates can have a particle size of up to 2 mm.

The aggregate material can be a fine aggregate. By “fine” is meant that the aggregate materials have particle sizes up to about 2.0 mm, or up to about 1.0 mm. In one non-limiting embodiment, the fine aggregates can have a particle size of up to 1 mm. The lower limit of particle size can be at least 0.0001 mm. In one non-limiting embodiment, the lower limit of particle size can be at least 0.001 mm.

The amount of aggregate material can be from about 15 wt % to about 85 wt % based on the total weight of the dry mortar composition. In one non-limiting embodiment, the amount of aggregate material added can be from about 20 wt % to about 80 wt % based on the total weight of the dry mortar composition. In another non-limiting embodiment, the amount of aggregate material added can be from about 25 wt % to about 80 wt %. In yet another non-limiting embodiment, the amount of aggregate can be from about 50 wt % to about 70 wt %.

Suitable inorganic compounds can include, but are not limited to, chlorides such as calcium chloride, sodium chloride and potassium chloride; nitrites such as sodium nitrite and calcium nitrite; nitrates such as sodium nitrate and calcium nitrate; sulfates such as calcium sulfate, sodium sulfate and alum; thiocyanates such as sodium thiocyanate and calcium thiocyanate; hydroxides such as sodium hydroxide, potassium hydroxide and calcium hydroxide; carbonates such as calcium carbonate, sodium carbonate and lithium carbonate; and alumina analogs such as water glass, aluminum hydroxide and aluminum oxide.

The surfactant used in the presently disclosed and claimed inventive concept(s) can be an anionic surfactant, an amphoteric surfactant, a cationic surf actani or a nonionic surfactant. Exemplary anionic surfactants contemplated for use in the presently disclosed and claimed inventive concept(s) can include, but are not limited to, a sulfate anion, sulfonate anion, carboxylate anion, or a mixture thereof. For example, but by no way of limitation, the anionic surfactant can be a sodium, potassium, or ammonium alkyl ethoxy sulfate having a C₆-C₁₆ alkyl group, such as sodium lauryl ethoxy sulfate. Further exemplary anionic surfactants may include sodium dodecyl sulfate, ammonium lauryl sulfate, sodium laureth sulfate, and/or alkyl benzene sulfonate.

Examples of the anionic surfactants can include, but are not limited to, alkylsulfates, alkylsulfonates, alkyl benzenesulfonates, alkyl polyoxyethylene ether sulfates, alkylpolyoxyethylene-propylene ether sulfates, sodium fatty alcohol succinic acid mono ester sulfonates, disodium fatty alcohol polyoxyethylene ether sulfosuccinates, disodium fatty alcohol polyoxyethylene-propylene ether sulfosuccinates, alkylpolyoxyethylene phosphates, alkylpolyoxyethylene-propylene phosphates and alkali metal salts of fatty acids, or mixtures thereof.

An exemplary cationic surfactant is a quaternary ammonium cation. These are positively charged polyatomic ions of the structure NR⁴⁺ with R representing alkyl groups. Unlike the ammonium ion NR⁴⁺ itself and primary, secondary, or tertiary ammonium cations, the quaternary ammonium cations are permanently charged, independent of the pH of their solution. Quaternary ammonium cations are synthesized by complete alkylation of ammonia or other amines. Exemplary quaternary ammonium cations include alkyltrimethylammonium salt, cetylpryridinium chloride (also referred to as hexadecyl trimethyl ammonium bromide), polyethoxylated tallow amine, benzalkonium chloride, and benzethonium chloride.

Exemplary amphoteric surfactants can include, but are not limited to, sodium lauhminodiprophonate, dodecyl betaine, dodecyl dimethylamine oxide, cocamidopropyl betaine, and coco ampho glycinate. (Note that the C₁₂ alkyl group can be replaced by a C₆-C₁₈ alkyl groups.) Amphoteric surfactants are also known as zwittehonic surfactants. Amphoteric compounds have both positive and negative charges on different atoms. In one non-limiting embodiment, the amphoteric surfactant can be sodium lauriminodipropionate.

Exemplary nonionic surfactants include, but are not limited to, alkyl alcohol polyoxyethylene ethers, polyethylene glycol, polypropylene glycol, linear alkyl alcohol polyoxyethylene-propylene ethers, branched alkyl alcohol polyoxyethylene ethers, branched alkyl alcohol polyoxyethylene-propylene ethers, fatty acid polyoxyethylenemonoesters, fatty acid polyoxyethylene-propylenemonoesters, alkoxylated dimethylpolysiloxane, alkyl modified siloxanes, fluorine modified siloxanes, mercapto modified siloxanes, hydroxy modified siloxanes, siloxane wax, polypropylene triol, butoxy polypropylene polyethylene glycol, polypropylene glycol, butoxy polypropylene polyethylene glycol, ethylene oxide/propylene oxide block copolymer, the esters of polyethylene glycol, ethylene oxide/propylene oxide block copolymer or mixtures thereof.

Defoamers used herein can include, but are not limited to, polyether, silicone, alcohol, hydrophobic silica, mineral oil, vegetable oil, and combinations thereof.

The cellulose ether used in the presently disclosed and claimed inventive concept(s) can be selected from the group consisting of alkylcelluloses, hydroxyalkylcelluloses, alkylhydroxyalkylcelluloses, optionally each with two or more different alkyl and/or hydroxyalkyl substituents, and mixtures of two or more of the before mentioned cellulose derivatives.

Alternatively, or additionally, the mixture composition according to the presently disclosed and claimed inventive concept(s) may comprise one or more water-soluble or at least water-swellable polysaccharides including, for example, but by no way of limitation, pectin, guar gum, guar derivatives like guar ethers, gum arabic, xanthan gum, dextran, cold-water-soluble starch, starch derivatives like starch ethers, chitin, chitosan, xylan, welan gum, succinoglycan gum, diutan gum, scleroglucan gum, gellan gum, mannan, galactan, glucan, alginate, arabinoxylan, cellulose fibers, and combinations thereof.

The following is a list of some examples of cellulose ethers which can be used in context with the presently disclosed and claimed inventive concept(s): hydroxyalkylcelluloses, e.g., hydroxyethylcellulose (HEC), hydroxypropylcellulose (HPC) and hydroxypropylhydroxyethylcellulose (HPHEC); carboxy-alkylcelluloses, e.g., carboxymethylcellulose (CMC); carboxyalkylhydroxyalkylcelluloses, e.g., carboxymethylhydroxyethylcellulose (CMHEC) and carboxymethyl-hydroxypropylcellulose (CMHPC); sulphoalkylcelluloses, e.g., sulphoethylcellulose (SEC) and sulphopropylcellulose (SPC); carboxyalkylsulphoalkylcelluloses, e.g., carboxymethylsulphoethylcellulose (CMSEC) and carboxymethylsulphopropylcellulose (CMSPC); hydroxyalkylsulphoalkylcelluloses, e.g., hydroxyethylsulphoethylcellulose (HESEC), hydroxypropylsulphoethylcellulose (HPSEC) and hydroxyethylhydroxypropylsulphoethylcellulose (HEHPSEC); alkylhydroxyalkylsulphoalkylcelluloses, e.g., methylhydroxyethylsulphoethylcellulose (MHESEC), methylhydroxypropylsulphoethylcellulose (MHPSEC) and methylhydroxyethylhydroxypropylsulphoethylcellulose (MHEHPSEC); alkylcelluloses, e.g., methylcellulose (MC) and ethylcellulose (EC); binary or ternary alkylhydroxyalkylcellulose, e.g., methylhydroxyethylcellulose (MHEC), ethylhydroxyethylcellulose (EHEC), methylhydroxypropylcellulose (MHPC) and ethylhydroxypropylcellulose (EHPC); ethylmethylhydroxyethylcellulose (EMHEC); ethylmethylhydroxypropylcellulose (EMHPC); alkenylcelluloses and ionic and nonionic alkenylcellulose mixed ethers, e.g., allylcellulose, allylmethylcellulose, allylethylcellulose and carboxy-methylallylcellulose); dialkylaminoalkylcelluloses, e.g., N,N-dimethylaminoethylcellulose and N,N-diethylaminoethylcellulose; dialkylaminoalkylhydroxyalkylcelluloses, e.g., N,N-dimethylaminoethylhydroxyethylcellulose and N,N-dimethylaminoethylhydroxypropylcellulose; aryl- and arylalkyl- and arylhydroxyalkylcelluloses, e.g., benzylcellulose, methylbenzylcellulose and benzylhydroxyethylcellulose; as well as reaction products of the above-stated cellulose ethers with hydrophobically modified glycidyl ethers, which have alkyl residues with about C₃ to about C₁₅ carbon atoms or arylalkyl residues with about C₇ to about C₁₅ carbon atoms.

The presently disclosed and claimed inventive concept(s) provides an emulsion/dispersion based composition comprising a polymer emulsion or dispersion powder, a hydrophobic additive, a filler, and a liquid component. The hydrophobic additives are the same as those described previously.

The hydrophobic additive can be present in an amount from about 0.01% to about 50% by weight based on the total weight of the emulsion/dispersion based composition. In one non-limiting embodiment, the hydrophobic additive can be present in an amount from about 0.01% to about 30% by weight based on the total weight of the emulsion/dispersion based composition. In another non-limiting embodiment, the hydrophobic additive can be present in an amount from about 0.5% to about 25% by weight based on the total weight of the emulsion/dispersion based composition. In yet another non-limiting embodiment, the hydrophobic additive can be present in an amount from about 1% to about 25% by weight based on the total weight of the emulsion/dispersion based composition.

The polymer emulsions or dispersion powder is selected from the group of vinyl-acetate ethylene copolymer, VAc/Veova copolymer, vinyl/acrylics copolymer, vinyl-acetate ethylene/acrylics copolymer, acrylics (co)polymer, styrene/acrylics copolymer, styrene-butadiene copolymer and other butadiene based polymers, polyurethane dispersions and combinations thereof.

In one non-limiting embodiment the polymer emulsions or dispersion powder is redispersible polymer powder. The redispersible polymer powder is the same as those described previously.

The polymer emulsions or dispersion powder is present in an amount from about 0.25% to about 50% by weight based on the total weight of the emulsion/dispersion based composition. In one non-limiting embodiment, the polymer emulsions or dispersion powder is present in an amount from about 0.4% to about 40% by weight based on the total weight of the emulsion/dispersion based composition. In another non-limiting embodiment, the polymer emulsions or dispersion powder is present in an amount from about 0.7% to about 30% by weight based on the total weight of the emulsion/dispersion based composition.

In one non-limiting embodiment, the liquid component can be water. The filler can be silica sands, calcium carbonate, calcium hydroxide, calcium sulphate dihydrate, dolomite, as well as light-weight aggregates such as perlites, polystyrene beads, hollow/expanded glass or ceramic spheres cork, rubber, and the like, and mixtures thereof. In one non-limiting embodiment, the proportion of filler in the emulsion/dispersion based composition can be between about 50% and about 85% by weight based on the total dry ingredients. In another non-limiting embodiment, the proportion of filler in the emulsion/dispersion based composition can be between about 60% and about 80% based on the total dry ingredients. In yet another non-limiting embodiment, the proportion of filler in the emulsion/dispersion based composition can be between about 65% and about 75% based on the total dry ingredients.

The emulsion/dispersion based composition of the presently disclosed and claimed inventive concept(s) can be a grout, a joint filler, a mastic, or a pasty system composition.

The pasty system composition of the presently disclosed and claimed inventive concept(s) can be formulated dispersion based “Reibeputz or textured plaster”, tile adhesive, structure-latex based render, silicate render, fine dispersion render for skim coat, tile grout on dispersion basis, acrylate based render, latex-based primer, and colorized latex-based renders or combinations thereof.

The emulsion/dispersion based composition of the presently disclosed and claimed inventive concept(s) further comprises a surfactant, a pigment, a defoamer, a thickener, a biocide, a pH controller, a dispersing agent, a wetting agent and combinations thereof.

The thickener of the presently disclosed and claimed inventive concept(s) is selected from the group consisting of methylhydroxylethyl cellulose (MHEC), hydroxyethyl cellulose (HEC), hydroxymethyl hydroxyethyl cellulose (HMHEC), and ethylhydroxyethyl cellulose (EHEC), hydrophobically modified hydroxyethylcellulose, hydroxypropyl methylcellulose (HPMC), hydroxypropyl guar, guar derivatives, and combinations thereof.

The surfactants and defoamers can be the same as those described previously.

A biocide is an important ingredient in a filler. It can increase the shelf life and prevent the compound from spoiling. In other words, the biocide can prevent microorganisms such as mold, bacteria and fungi, from growing in the compound and also on the walls of the building structure in which it is used. Examples of two efficient industry-accepted biocides can be Mergal® 174, 2[(hydroxymethyl)amino]ethanol, a broad spectrum biocide, manufactured by Troy Chemical Corp; and Proxel™ GXL product, 1,2-benzisothiazolin-3-one, an all purpose biocide, manufactured by Arch Chemicals, Inc.

Other biocides can include, but are not limited to, copper oxine, zinc stearate, calcium borate, zinc borate, barium borate, zinc omadine, zinc omadine/zinc oxide mix, 2,5-dimethyl-1, 3, 5-thiadiazinane-2-thione (Thione), 2-n-octyl-4-isothiazolin-3-one (octhilinone), 5-chloro-2-methyl-4-isothiazolin-3-one, 2-methyl-4-isothiazolin-3-one, hexahydro-1,3,5-triethyl-2-triazine, 5-bromo-5-nitro-1,3-dioxane, 2-(hydroxymethyl)amino-ethanol, 2-(hydroxymethyl)amino-2-methylpropanol, α-benzoyl-α-chloroformaldoxime, benzylbromoacetate, p-chloro-m-xylenol, bis-(2-hydroxy-5-chlorophenyl)sulfide, p-tolydiiodomethylsulfone, 3-iodo-2-propynylbutylcaramate, bis-(2-hydroxy-5-chlorophenyl) methylene, dipropylamine ether, dodecylamine, and 1-(3-chloroallyl)-3,5,7-triaza-1-azoniaadamantane chloride.

The biocide can generally be present in the amount ranging from a lower limit of about 0.05 to an upper limit of about 1% by weight based on the total weight of the emulsion/dispersion based composition.

In one non-limiting embodiment, the pigment is selected from the group consisting of hydrated aluminum oxide, barium sulfate, calcium silicate, lay, silica, talc, titanium dioxide, zinc oxide, magnesium aluminum silicate, and mixtures thereof. Oftentimes, titanium dioxide grades used in the emulsion/dispersion based composition are surface modified with various inorganic oxides, such as silicates, aluminates, and zirconates. Aluminum silicate, nepeline syenite, mica, calcium carbonate, and/or diatomaceous earth can also be employed.

Suitable pH controller can be ammonia, ammonium hydroxide solution, an organoamine compound, and potassium or sodium solution. Examples of suitable organoamine compounds can include, but are not necessarily limited to, tetraethylenepentamine, triethylenetetramine, pentaethylenehexamine, triethanolamine, and the like, or any mixtures thereof. pHLEX™ 400 and pHLEX™ 410 are organoamine blends which are commercially available from Ashland Inc. and used in the presently disclosed and claimed inventive concept(s). The pH controller can generally be present in the amount ranging from about 0.01% to about 0.5% by weight based on the total weight of the emulsion/dispersion based composition. The target pH can be in the range of about 7.5 to about 14.

Suitable dispersing agents can include, but are not limited to, polycarboxy acid-based dispersing agent such as an acrylic copolymer containing an alkyl acrylate or methacrylate. The commercially available dispersing agents used in the presently disclosed and claimed inventive concept(s) can include, but are not limited to, Jaypol™ S44, Jaypol™ S40, and Jaypol™ S100, which are available from Ashland Inc. A dispersing agent can be present in an amount ranging from about 0.01% to about 0.8% by weight based on the total weight of the emulsion/dispersion based composition.

The wetting agents which can be utilized in the presently disclosed and claimed inventive concept(s) can include, but are not limited to, non-ionic ethoxylated fatty alcohols or their anionic sulfate salts. Examples of the non-ionic ethoxylated fatty alcohols which can be used include ethoxylated nonylphenols with 3 to 12 moles of ethylene oxide and siloxane ethyoxylate-based surfactant. Examples of the anionic sulfate salts of ethoxylated fatty alcohols which can be used include fatty acid alcohol ether sulfates where the fatty acids are lauryl, coco or the like and are ethoxylated with from 3 to 12 moles of ethylene oxide and then sulfated.

The commercially available dispersing agents used in the presently disclosed and claimed inventive concept(s) can include, but are not limited to, Dextrol™ OC-180 and Strodex™, which are available from Ashland Inc. A wetting agent can be present in an amount ranging from about 0.01% to about 0.8% by weight based on the total weight of the emulsion/dispersion based composition.

Tables 1-3 list the composition for typical pasty systems.

TABLE 1
Formulation Dispersion Based “Reibeputz or Textured Plaster”

| Composition | Wt % |
|---|---|
| Water | 4-8 |
| Polymer dispersion (Mowilith ® LDM 1865 WP)* | 14 |
| Biocide | 0.2 |
| Defoamer | 0.2 |
| Cellulose ether | 0.2 |
| pH control (Ammonia NH₄OH) | 0.1 |
| Calcium carbonate, Durcal 65 (available from Omya) | 33 |
| Silica sand, F35 | 27 |
| Calcium carbonate, structuring gravel (Inducarb 1.5-2 mm) | 17 |
| Thickener, optional | 0.2 |

*a vinyl acetate ethylene water-based emulsion, commercially available from Celanese

TABLE 2
Tile Adhesive D2T

| Composition | Wt % |
|---|---|
| Water | 7 |
| Emulsion (styrene-acrylate) | 20 |
| Biocide (Nuosept ™ BIC)⁽¹⁾ | 0.1 |
| Defoamer (Drewplus ™ L-1500/1600)⁽²⁾ | 0.2 |
| Cellulose ether (Natrosol ™ 250HBXR, available | 0.4 |
| from Ashland Inc.) | |
| pH-control (pHLEX ™ 400)⁽³⁾ | 0.1 |
| Dispersing agent (Jaypol ™ S44)⁽⁴⁾ | 0.2 |
| Wetting agent (Dextrol OC-180)⁽⁵⁾ | 0.2 |
| Carbonate filler different fractions (0-150 μm) | 71.4 |
| Rheological modifier⁽⁶⁾ | 0.4 |

⁽¹⁾A formaldehyde-free water-based preservative with a blend of 1,2-benzisothiazol-3(2H)-one (BIT), 3-iodo-2-propylbutylcarbamate (IPBC) and 3:1 mixture of 5-chloro-2-methyl-2H-isothiazol-3-one (CMIT)/2-methyl-2H-isothiazol-3-one (MIT), commercially available from Ashland Inc.
⁽²⁾A defoamer, commercially available from Ashland Inc.
⁽³⁾An organoamine blend, commercially available from Ashland Inc.
⁽⁴⁾A sodium salt of an acrylic polymer in water, commercially available from Ashland Inc.
⁽⁵⁾Phosphate ester, commercially available from Ashland Inc.
⁽⁶⁾The rheological modifier used can depend on other ingredients in the system. It can be polyacrylate thickener or fibers (Jaypol ™ AL, Jaypol ™ AT 4, Aquaflow ™ XLS 500 and Aquaflow ™ XLS 520, which are all commercially available from Ashland Inc.). The final solution is neutralized with ammonium or sodium hydroxide to a pH to about 7 to about 12.

TABLE 3
Structure-Latex Based Render

| Composition | Wt % |
|---|---|
| Water | 12 |
| Dispersion (VAE) | 7 |
| Silicone resin dispersion | 3 |
| Defoamer (Drewplus L-1500/1600) | 0.2 |
| Cellulose ether (Natrovis ™ E150000R)* | 0.15 |
| pH-controller (pHLEX ™ 400) | 0.25 |
| Dispersing agent (Jaypol ™ S44) | 0.2 |
| Thickening agent (Jaypol ™ AS 40)** | 0.1 |
| Filler different fractions up to 2 mm | 76.5 |
| Fiber | 0.1 |
| Rheological modifier | 0.3 |
| Film-forming agent (optional)*** | 0.2 |

*Hydroxyethyl cellulose, commercially available from Ashland Inc.
**A sodium salt of an acrylic polymer in water, commercially available from Ashland Inc.
***Lexanol ® CA 5308, commercially available from BASF.

The liquid ingredients listed in each above table can be mixed for about 5 minutes with low shear of about 350 rpm. Then the solid ingredients are added and mixed with the liquid ingredients for about 5 minutes at high shear of about 700 rpm. The pH controller is added to adjust the pH of the mixture at high shear of about 700 rpm to form a pasty system. The water adsorption of the pasty system can be determined by the water permeability. This test method is described in EN 1062-3.

Hydrophobicity of a blend of new hydrophobic additives with polymer emulsion or powders can be compared with the hydrophobicity of emulsion or powder containing zinc-stearates as a state-of-the-art-product.

The expectation of the use of the new modified polymer emulsion can improve the water resistant and long-life-resistance against water permeability. Furthermore, it is capable of withstanding exposure to weather without damages.

The following examples illustrate the presently disclosed and claimed inventive concept(s), parts and percentages being by weight, unless otherwise indicated. Each example is provided by way of explanation of the presently disclosed and claimed inventive concept(s), not limitation of the presently disclosed and claimed inventive concept(s). In fact, it will be apparent to those skilled in the art that various modifications and variations can be made in the presently disclosed and claimed inventive concept(s) without departing from the scope or spirit of the invention. For instance, features illustrated or described as part of one embodiment, can be used on another embodiment to yield a still further embodiment. Thus, it is intended that the presently disclosed and claimed inventive concept(s) covers such modifications and variations as come within the scope of the appended claims and their equivalents.

### EXAMPLES

A dry tile grout mortar was prepared in Examples 1-3. The basic tile grout mortar ingredients used in these examples are listed in Table 4.

TABLE 4
Dry Tile grout Mortar Formulation

| Composition | grams |
|---|---|
| Portland cement CEM 42.5R Weiβ (Dycjerhoff) | 840 |
| Fine silica sand F35 | 840 |
| CaCO₃ (Durcal 65) | 300 |
| Dispersion/emulsion/Redispersible powder (modified | 20 |
| or non-modified) | |
| Cellulose ether MHEC 6000 PFS | 1.0 |

Tile Grout Mortar Preparation for Testing

2000 g of dry tile grout mortar was added to a certain amount of water within 15 seconds to form a sample. The amount of water added was determined based on comparable (250,000 to 300,000 mPas) Helipath viscosity. The sample was mixed for about 30 seconds in a Hobart mixer. Then, the beaker wall of the mixer was cleaned within about 1 minute. The sample was re-mixed again for a minute to form a tile grout mortar sample. The tile grout mortar sample was allowed to rest for about 5 minutes. The tile grout mortar sample was remixed for 15 seconds on step 1 with Hobart mixer. After mixing, the Helipath viscosity of the mortar was determined and the tile grout mortar was carefully filled into a form with height of 80 mm, width 40 mm and length of 40 mm. The form was positioned horizontally.

For the water absorption tests on prism, the prepared prisms were taken out of the form after 24 hours. Water absorption tests on tile grout prism were conducted after storage in a climate room (50% RH, 23° C.) for 28 days. The prisms were sealed with silicone on 5, 12 and 21^{th} day after preparation. The prisms were weighed out and arranged with the head area of the prisms placed in water on the 7, 14 and 28^{th} day. The water height was fixed to 10 mm. After storage in water for 240 minutes the prisms were take out and re-weighed. The difference of the weight before and after storage in water was measured. A low water uptake value corresponds with an excellent hydrophobicity.

### Example 1

Hydrophobicity of tile grout mortars that contained various blends of Aquapel™ 320 and Aquapas™ N2098 (commercially available redispersible powder from Ashland, Inc.) as hydrophobic agent were compared with tile grout mortars that contained stearates as hydrophobic agent. Hydrophobic test results were measured for a period of 7, 14 and 28 days.

TABLE 5

| | Hydrophobicity | Hydrophobicity | Hydrophobicity |
|---|---|---|---|
| Sample | after 7 days | after 14 days | after 28 days |
| 10% Zn-Stearate + | 2.8 g | 2.8 g | 2.9 g |
| 90% Aquapas ™ | | | |
| N2098 | | | |
| 10% Aquapel ™ | 2.46 g | 2.46 g | 2.7 g |
| 320 + 90% | | | |
| Aquapas ™ N2098 | | | |

### Example 2

Tile grout mortars containing blend of Prequel™ 2000E emulsion and Celvolit® 1388 (commercially available copolymer emulsion of vinyl acetate and ethylene from Celanese Emulsions GmbH) at various ratios were prepared and hydrophobicity of these samples were compared with tile grout mortars containing zinc-stearates as hydrophobic additive.

The Prequel™ 2000E emulsion was prepared as follows:

135 gram distilled water and 15 gram Prequel™ 2000E were mixed and stirred for about 1 minute to form 10% solution. The pH of the solution was around 5. The pH of the solution was adjusted to 11 by adding about 5.5 gram of 32 wt % NaOH. This solution was heated for about 30 minutes at about 90° C. After cooling down, 0.30 gram wheat starch was added and the solution was re-stirred for making an emulsion. This Prequel™ 2000E emulsion was used fresh for the tests in tile grout mortar as a solution with 10 wt % active content.

TABLE 6

| | Hydrophobicity | Hydrophobicity | Hydrophobicity |
|---|---|---|---|
| Sample | after 7 days | after 14 days | after 28 days |
| 10% Zn-Stearate + | 2.05 g | 2.05 g | 2.45 g |
| 90% Celvolit ® 1388 | | | |
| 20% Prequel ™ | 1.1 g | 1.1 g | 1.7 g |
| 2000E + 80% | | | |
| Celvolit ® 1388 | | | |

### Example 3

Hydrophobicity of tile grout mortars containing a blend of Wetcare™ and Celvolit® 1388 with various ratios were compared with the hydrophobicity of tile grout mortars containing zinc-stearate hydrophobic additive.

TABLE 7

| | Hydrophobicity | Hydrophobicity | Hydrophobicity |
|---|---|---|---|
| Sample | after 7 days | after 14 days | after 28 days |
| 10% Zn-Stearate + | 1.6 g | 1.6 g | 1.7 g |
| 90% Celvolit ® | | | |
| 1388 | | | |
| 20% Wetcare ™ + | 1.2 g | 1.5 g | 1.55 g |
| 80% Celvolit ® | | | |
| 1388 | | | |

The hydrophobicity was also determined with the dissolution time of polymer films in Examples 4 and 5.

### Example 4

2 grams of polymer emulsion and hydrophobic agent, 3 gram of tap water and 0.2 g of calcium carbonate (Durcal 2) were used for preparing a polymeric film. The relative amounts of the polymer emulsion and hydrophobic agent were varied.

All the above ingredients were filled into a cup with a volume of 400 gram. The mixing of the ingredients was 30 seconds on step 1 with hand mixer and 2 Kneaders. The resulting liquid was filled in a petri dish and stored for 3 days. The film was put under the microscope and one water droplet was put on the surface of the film. The time to dissolve the film was measured and pictures were taken.

The microscope adjustment was 1× objective with 0.7 zoom ratio with both lamps being turned on. The longer the time to dissolve the film the better was the hydrophobicity.

TABLE 8
Comparison of Film Dissolution Time

| Hydrophobic Agent | Celvolit ® 1388 | Hydrophobic effect |
|---|---|---|
| | 100% | 1 minute |
| 10% Zn-Stearate | 90% | 5 minutes |
| 10% Wetcare ™ | 90% | 12 minutes |
| 20% Wetcare ™ | 80% | 45 minutes |

### Example 5

Hydrophobicity of a blend of Prequel™ 710+Prequel™ 2000E with Celvolit® 1388 was compared with the hydrophobicity of emulsion containing zinc-stearates.

TABLE 9
Comparison of Film Dissolution Time

| Hydrophobic Agent | Celvolit ® 1388 | Hydrophobic effect |
|---|---|---|
| | 100% | 1 minute |
| 10% Zn-Stearate | 90% | 5 minutes |
| 20% (75% Prequel ™ 2000E + | 80% | 20 minutes |
| 25% Prequel ™ 710) | | |

What is claimed is:

1. A dry mortar composition comprising:
at least one polymer emulsion or dispersion powder;
at least one hydrophobic additive; and
a cement,
wherein the hydrophobic additive is selected from the group consisting of alkenyl succinic anhydride, alkyl/alkenyl ketene dimers, polyolefin/paraffin wax dispersions/emulsions cross-linked with zirconium metal chelates, cationic starch, polymer stabilized dispersions of alkenyl succinic anhydride and alkyl/alkenyl ketene dimmers, and combinations thereof.

2. The dry mortar composition of claim 1, wherein the polymer emulsions or dispersion powder is selected from the group consisting of vinyl-acetate ethylene copolymer, VAc/Veova copolymer, vinyl/acrylics copolymer, vinyl-acetate ethylene/acrylics copolymer, acrylics (co)polymer, styrene/acrylics copolymer, styrene-butadiene and other butadiene polymers, polyurethane dispersions and combinations thereof.

3. The dry mortar composition of claim 1, wherein the polymer emulsions or dispersion powder is present in an amount of from about 0.25% to about 50% by weight based on the total weight of the dry mortar composition.

4. The dry mortar composition of claim 1, wherein the hydrophobic additive is present in an amount of from about 0.01% to about 1% by weight based on the total weight of the dry mortar composition.

5. The dry mortar composition of claim 1, wherein the cement is selected from a group consisting of hydraulic cements, portland cement, composite cements, blast furnace slag cement, limestone cement, pozzolans cement, fly ash cement, silica fume cement, and alumina cement and combinations thereof.

6. The dry mortar composition of claim 1, wherein the polymer emulsions or dispersion powder is a redispersible polymer powder.

7. The dry mortar composition of claim 1 further comprising an aggregate material, an inorganic compound, a surfactant, a defoamer, and cellulose ether.

8. The dry mortar composition of claim 7, wherein the aggregate material is selected from the group consisting of silica sands, dolomite, limestone, perlites, polystyrene beads, hollow/expanded glass, ceramic spheres cork, rubber, fly ash and combinations thereof.

9. The dry mortar composition of claim 7, wherein the inorganic compound is selected from the group consisting of calcium carbonate, calcium hydroxide, calcium sulphate dehydrate, calcium chloride, sodium chloride, potassium chloride, sodium nitrite, calcium nitrite, sodium nitrate, calcium nitrate, sodium sulfate, alum, sodium thiocyanate, calcium thiocyanate, sodium hydroxide, potassium hydroxide, sodium carbonate, lithium carbonate, water glass, aluminum hydroxide, aluminum oxide, and combinations thereof.

10. The dry mortar composition of claim 7, wherein the aggregate material is between about 15% and about 85% by weight, based on the total dry mortar composition.

11. The dry mortar composition of claim 7, wherein the cellulose ether is selected from the group consisting of alkylcelluloses, hydroxyalkylcellluloses, alkylhydroxyalkylcelluloses, and combinations thereof.

12. An emulsion/dispersion based composition comprising:
a polymer emulsion or dispersion powder;
a hydrophobic additive;
a filler; and
a liquid component,
wherein the hydrophobic additive is selected from the group consisting of alkenyl succinic anhydride, alkyl/alkenyl ketene dimers, polyolefin/paraffin wax dispersions/emulsions cross-linked with zirconium metal chelates, cationic starch or polymer stabilized dispersions of the alkenyl succinic anhydride, and alkyl/alkenyl ketene dimmers.

13. The emulsion/dispersion based composition of claim 12, wherein the composition is a grout, a joint filler, a mastic, a pasty, textured plaster, tile adhesive, structure-latex based render, silicate render, fine dispersion render for skim coat, dispersion based tile grout, acrylate based render, latex-based primer, colorized latex-based renders, or combinations thereof.

14. The emulsion/dispersion based composition of claim 12, wherein the filler is selected from the group consisting of silica sands, calcium carbonate, calcium hydroxide, calcium sulphate dehydrate, dolomite and combinations thereof.

15. The emulsion/dispersion based composition of claim 12, wherein the filler is present in amount between about 15% and about 85% of the total emulsion/dispersion based composition.

16. The emulsion/dispersion based composition of claim 12, wherein the polymer emulsions or dispersion powder is selected from the group consisting of vinyl-acetate ethylene copolymer, VAc/Veova copolymer, vinyl/acrylics copolymer, vinyl-acetate ethylene/acrylics copolymer, acrylics (co)polymer, styrene/acrylics copolymer, styrene-butadiene, butadiene based polymers, polyurethane dispsersions and combinations thereof.

17. The emulsion/dispersion based composition of claim 12, wherein the polymer emulsions or dispersion powder is present in an amount between about 0.4% and about 40% of the total emulsion/dispersion based composition.

18. The emulsion/dispersion based composition of claim 12, wherein the hydrophobic additive is present in an amount from about 0.01% to about 50% by weight based on the total weight of the filled composition.

19. The emulsion/dispersion based composition of claim 12, wherein the polymer emulsions or dispersion powder is redispersible polymer powder.

20. The emulsion/dispersion based composition of claim 12, wherein the liquid component is water.

21. The emulsion/dispersion based composition of claim 12, further comprising a surfactant, a pigment, a pH controller, a biocide, a dispersing agent, a wetting agent, a defoamer, and a thickener.

22. The emulsion/dispersion based composition of claim 12, wherein the thickener is selected from the group consisting of methylhydroxylethyl cellulose (MHEC), hydroxyethyl cellulose (HEC), hydroxymethyl hydroxyethyl cellulose (HMHEC), and ethylhydroxyethyl cellulose (EHEC), hydrophobically modified hydroxyethylcellulose, hydroxypropyl methylcellulose (HPMC), hydroxypropyl guar, guar derivatives, and combinations thereof.
